(19) United States
(12) Patent Application Publication
(10) Pub. No.: US 2001/0035642 A1
(43) Pub. Date: Nov. 1, 2001

(54) Stabilizing device for an instrument panel arranged in a variable position in a motor vehicle

(76) Inventors: Franz Gotz, Villingen-Schwenningen (DE); Stefan Funk, Villingen-Schwenningen (DE)

Correspondence Address: David Toren, BROWN & WOOD LLP, One World Trade Center, New York, NY, 10048-0557, US

(21) Appl. No.: 09/843,013

(22) Filed: Apr. 26, 2001

(30) Foreign Application Priority Data
Apr. 27, 2000 (DE) 200 07 526.8

(51) Int. Cl. B62D 1/16

(52) U.S. Cl. 280/779; 280/80.1

(57) ABSTRACT

In a stabilizing device provided for jointly raising and lowering and also pivoting the steering wheel or steering column and the instrument panel, toothings (45, 46) assigned to guide rails (37, 38) are formed directly on the guide rails (37, 38). At the same time, the guide rails (37, 38) are shaped in such a way that the toothings (45, 46) point toward the guide plane or a supporting shaft (50), said guide plane being determined by slots (39, 40). Twist-preventing profiles are formed at the ends of the supporting shaft (50), and gearwheels (51, 52) which are assigned to the supporting shaft and are assigned means for axial securing are connectable to the supporting shaft (50) solely in a pluggable manner.

### BACKGROUND OF THE INVENTION

1. Field of the Invention

The invention relates to a stabilizing device for an instrument panel which is arranged in a variable position in a motor vehicle and which, on the one hand, is fixedly connected to a steering column carrying the steering wheel and mounted axially adjustably and pivotably and, on the other hand, is held in a variable position by means of the stabilizing device comprising a carrier which is capable of being fastened to a front frame of the driver's cab of a vehicle and which is provided with guide rails which are arranged parallel to one another and carry toothings and in which slots are formed parallel to the toothings, having a supporting shaft which passes through the slots and on which are fastened gearwheels in engagement with the toothings of the guide rails, and containing an axially acting clamping means arranged on the supporting shaft and intended for detaining the supporting shaft between the guide rails.

2. Description of the Prior Act

As is known, in order to achieve an ergonomically optimum body posture for driving a vehicle, for example in the case of omnibuses, in particular public service buses, in which the drivers often change and women may also act as drivers, there is not only provision for an adjustability of the driver's seat, but also for an axial adjustment and pivoting of the steering wheel, specifically together with the instrument panel of the vehicle. That is to say, by the simultaneous adjustment of the steering wheel and instrument panel, a raised, less inclined steering wheel position and an instrument-panel instrument plane having a lower inclination in the same way can be achieved for a relatively large driver of either sex and a lowered, more inclined steering wheel position and an instrument-panel instrument plane having a steeper inclination in the same way can be achieved for a relatively small driver of either sex. At the same time, however, it must be remembered that the instrument panel of omnibuses, of commercial vehicles in general, constitutes, with a span of the order of magnitude of 900 mm and a movable weight of 25 kp, a relatively large and far-overhanging mass which not only should be easily adjustable, particularly without any tilting, but must also be suspended in a vibrationally safe manner.

By means of a suitable stabilizing device, such as is described in the precharacterizing clause of claim 1, an instrument panel is supported over a relatively large width and, in the event of a change in position of the structural unit formed from the steering column and instrument panel, tilting is avoided. That is to say, the slotted guide of the respective guide rails, which is combined with a gearwheel/rack connection, brings about a uniform distribution of the forces occurring during the raising and lowering and during the pivoting of the steering-column/instrument panel structural unit. The stabilizing device is also assigned the detention of the steering-column/instrument-panel structural unit, in that a spring-loaded, pneumatically releasable clamping element is received loosely on the supporting shaft, the force flux being closed via clamping sleeves held by the supporting shaft, the guide rails, the gearwheels and the tension-loaded supporting shaft.

The area of use for an instrument panel adjustable in a variable position in the way described is known to presuppose high operating safety, along with costs which are as low as possible, the capacity for mass production and relatively easy mountability. In addition, components which are at risk of failure, such as, for example, the clamping element, can be exchanged in a simple way, the axial play necessary for the adjustability of the instrument panel being capable of being set without any appreciable outlay. The object of the present invention was, therefore, to revise the design of a stabilizing device known per se, to the effect that the production costs are appreciably reduced. A further aim is to simplify mounting, in particular as regards the setting of the axial play of the gearwheels.

### SUMMARY OF THE INVENTION

The solution for achieving the set object is characterized in that the toothing assigned to a guide rail is formed directly on the guide rail and the guide rail is shaped in such a way that the toothing points toward the guide plane of the supporting shaft, said guide plane being determined by the slot, in that a twist-preventing profile is formed at each of the ends of the supporting shaft, in that the gearwheels are connectable to the supporting shaft solely in a pluggable manner, and in that means are provided for securing the gearwheels axially on the supporting shaft.

A preferred exemplary embodiment is distinguished, furthermore, in that the gearwheels are secured axially in each case by means of a stop nut which is connectable to the supporting shaft and is assigned a twist-preventing means, retaining washers being provided for the stop nuts as twist-preventing means, in that an arm is formed on each retaining washer, in that a structure cooperating in a twist-preventing manner with the arms is integrally formed on the gearwheels, and in that at least one tab is formed on each of the retaining washers in such a way that said tab can be connected positively to the respective stop nut.

The remaining subclaims describe expedient embodiments of the invention.

The decisive advantage which the invention affords is to be seen, in particular, in that the toothings are formed directly on the guide rails and, in order to provide engagement with the gearwheels arranged on the supporting shaft, the guide rails are bent round 180° parallel to the slots. Additional racks, such as the prior art provides, which are to be mounted on the guide rails, are no longer necessary by virtue of the invention. Moreover, considerable reinforcement is achieved for the guide rails, for which preferably a fine-grained steel is used on account of the narrow bending radius and a relatively large sheet-metal thickness of the order of magnitude of 4 mm. It may also be envisaged that, as mentioned in claim 2, the guide rails, together with the integrally formed “racks”, and the carrier are produced as one structural part.

Moreover, for noise reduction, it is, however, also advisable, for reasons of cost, to produce the gearwheels from plastic by injection molding, metallic centering bushes being embedded in the gearwheels. The connection between the supporting shaft and the gearwheels is made positively in order to achieve absolute twist prevention, for example the ends of the supporting shaft are designed as a D-profile and the centering bushes of the gearwheels are correspondingly provided with orifices of D-shaped cross section. This results in simple mounting and, in the event that the clamping element has to be exchanged, in easy releasability of the gearwheels.

The preferred arrangement according to the invention of the gearwheels on the supporting shaft, which, for securing the gearwheels axially, provides in each case a stop nut screwed onto the supporting shaft and in each case a retaining washer positively connecting a stop nut and a gearwheel and serving as twist-preventing means, makes it possible, furthermore, for the axial play between the gearwheels and the guide rails, which is critical for the functioning of the stabilizing device, to be set quickly and sensitively.

### BRIEF DESCRIPTION OF THE DRAWINGS

The invention will be explained in more detail below with reference to the accompanying drawings in which:

FIG. 1 shows a side view of a general illustration of the steering-column/instrument-panel structural unit according to the invention.

FIG. 2 shows a side view of the stabilizing device,

FIG. 3 shows a perspective illustration of the stabilizing device, looking toward the fastening plane on a frame fixed to the vehicle, according to the arrow A,

FIG. 4 shows a part section through the stabilizing device in the plane of the supporting shaft,

FIG. 5 shows an enlarged perspective part illustration of FIG. 3, looking in the direction of the arrow B in FIG. 3.

### DETAILED DESCRIPTION OF THE PREFERRED EMBODIMENT

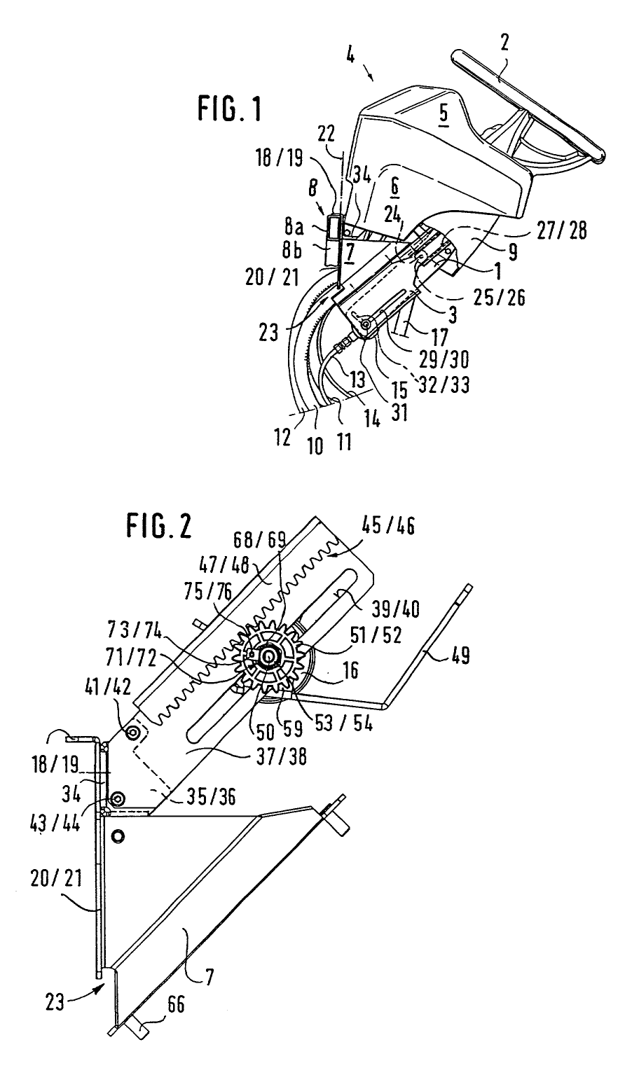

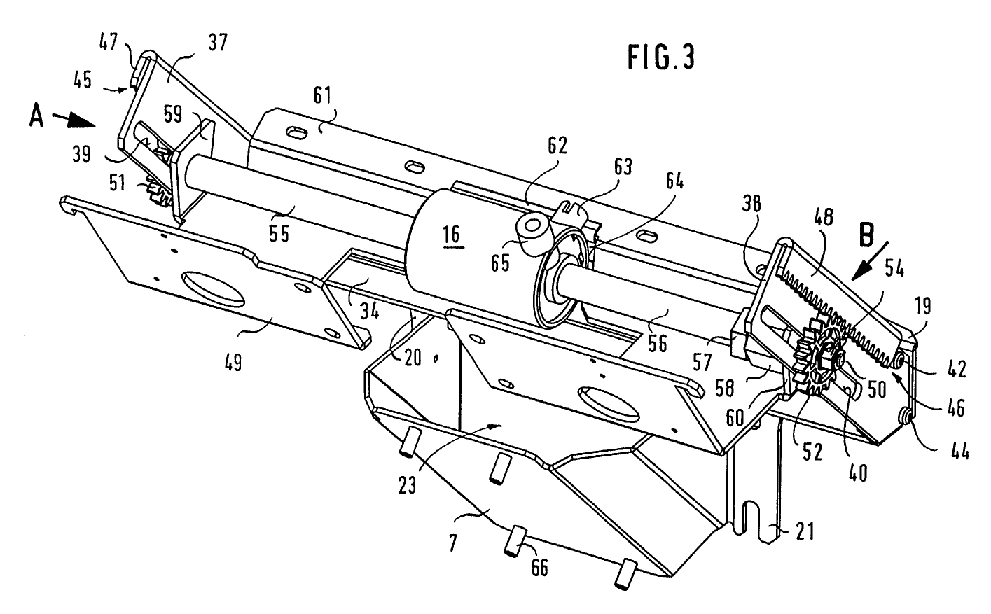

As may be gathered from the general illustration in FIG. 1, a steering column 1, in which the shaft, not illustrated, of a steering wheel 2 is mounted, or a holding frame 3 assigned to the steering column 1 and an instrument panel 4, of which the body receiving the indicating and recording instruments, switches and other control elements is assembled from two shells 5, 6, are assigned to a bracket 7 which is supported on a front frame 8 of the driver's cab of the respective vehicle and is fastened in a suitable way, preferably by means of screws. Said frame 8 is formed, in this case, by a transverse spar 8a of the driver's cab and by preferably two supports 8b welded to the transverse spar 8a and reaching as far as the floor of the driver's cab. A cladding of the steering column 1 is designated by 9; the reference symbols 10 and 11 refer to ventilation hoses led to the instrument panel 4; a protective hose for the electrical connections of the instrument panel 4 is designated by 12. Two lines 13 and 14 constitute compressed-air lines. These are connected in each case to clamping elements 15 and 16 (FIGS. 2 and 3) which serve for detaining the steering-column/instrument panel structural unit. An element of a cardan shaft leading to the steering gear and connected to the shaft of the steering wheel is designated by 17. This element of the cardan shaft is preferably designed as a telescopic shaft provided with a pneumatic spring.

For the sake of completeness, it may be mentioned, in connection with FIG. 1, that holding battens 18, 19 serving for flanging the steering-column/instrument-panel structural unit to the frame 8, and supporting arms 20, 21 are integrally formed on the bracket 7 and the fastening plane of the bracket 7 provided with a cable and air-hose duct 23 is designated by 22. It may also be started, as regards the functioning of the structural unit, that the pivoting takes place about an axis of rotation 24 which is fixed to the steering column and on which ball bearings serving as running rollers 25, 26 are fastened on both sides of the steering column 1 designed, for example, as a U-profiled body. The running rollers 25, 26 engage, in turn, into slots formed as grooves 27, 28 in the holding frame 3. The steering column 1 finds a second guide in slots which are likewise made in the holding frame 3 and are designed as ports 29, 30 and which, using a spindle 31 engaging into the two ports 29, 30 and assigned to the steering column 1, limit the stroke of the steering column 1. The spindle 31 itself serves, in turn, as a stop for the pivoting movement of the steering column 1, in that the spindle 31 passes through suitable long holes 32, 33 provided in the side walls of the steering column 1. As is evident from FIG. 1, the spindle 31 has arranged on it the clamping element 15 which serves for the nonpositive connection of the holding frame 3 and steering column 1 and therefore the detention of the steering column 1 in a specific lifting/pivoting position.

The carrier of the stabilizing device assigned to the steering-column/instrument-paddle structural unit is designated by 34. The carrier 34 is fastened to the frame 8 jointly with the bracket 7, the bracket 7 and carrier 34 expediently being premounted. In the production state according to FIGS. 2 and 3, the premounting of the bracket 7 and carrier 34, using suitable screw connections (dashed and dotted line in FIG. 2), has already taken place. Guide rails 37, 38, in which slots 39, 40 are formed, are fastened parallel to one another on the carrier 34 which is designed as a U-profile and is provided with legs 35, 36. The screw connections provided for fastening the guide rails 37, 38 to the carrier 34 are designed by 41, 42 and 43, 44. In addition to the slots 39, 40, toothings 45, 46 are formed directly on the guide rails 37, 38, specifically in such a way that said toothings point toward a guide plane determined by the slots 39, 40. That is to say, inter alia, toothed strips 47, 48 carrying the toothings 45, 46 and the slots 39, 40 lie in parallel planes. A bearing part is designated by 49, which, on the one hand, is permanently assigned to the lower shell of the instrument panel 4 and, on the other hand, is mounted pivotably on a supporting shaft 50. Said supporting shaft passes with its ends through the slots 39, 40 in the guide rails 37, 38 and carries gearwheels 51, 52 which are in engagement with the toothings 45, 46 and, as is also explained in more detail below, are secured axially by means of stop nuts 53, 54.

For clearer reference, in FIG. 3 arrow A marks the viewing direction in which the side view of the stabilizing device according to FIG. 2 can be seen. It is also evident from FIG. 3 that the clamping device according to FIG. 3 that the clamping element 16, placed loosely on the supporting shaft 50, is assigned clamping sleeves 55 and 56 which are likewise held loosely on the supporting shaft 50. Arranged on the clamping sleeve 56, which is provided with a thread, not designated in any more detail, are adjusting nuts 57, 58 which are lockable relative to one another and serve for setting an axial play of the combination of the clamping sleeves 55, 56 and of the clamping element 16 between the guide rails 37, 38 of, for example, 0.2 mm. Designated by 59 and 60 are bearing legs which are integrally formed on the bearing part 49 and via which the instrument panel 4 is mounted on the clamping sleeves 55, 56 and is thus connected in an articulated manner to the supporting shaft 50. An elastomeric strip, designed by 62, is attached to a fastening rail 61 of the bearing part 49, said fastening rail being provided with a suitable integrally formed on the housing of the clamping element 16 and thereby prevents a rotational movement of the clamping element 16 on the supporting shaft 50 of the clamping element 16 on the supporting shaft 50 in relation to the bearing part 49. A connection piece 65, illustrated diagrammatically, provided with an orifice, not designated, serves for connecting the compressed-air line 14. A threaded bolt pressed in the bracket 7 and serving for fastening the holding frame 3 is designated by 66.

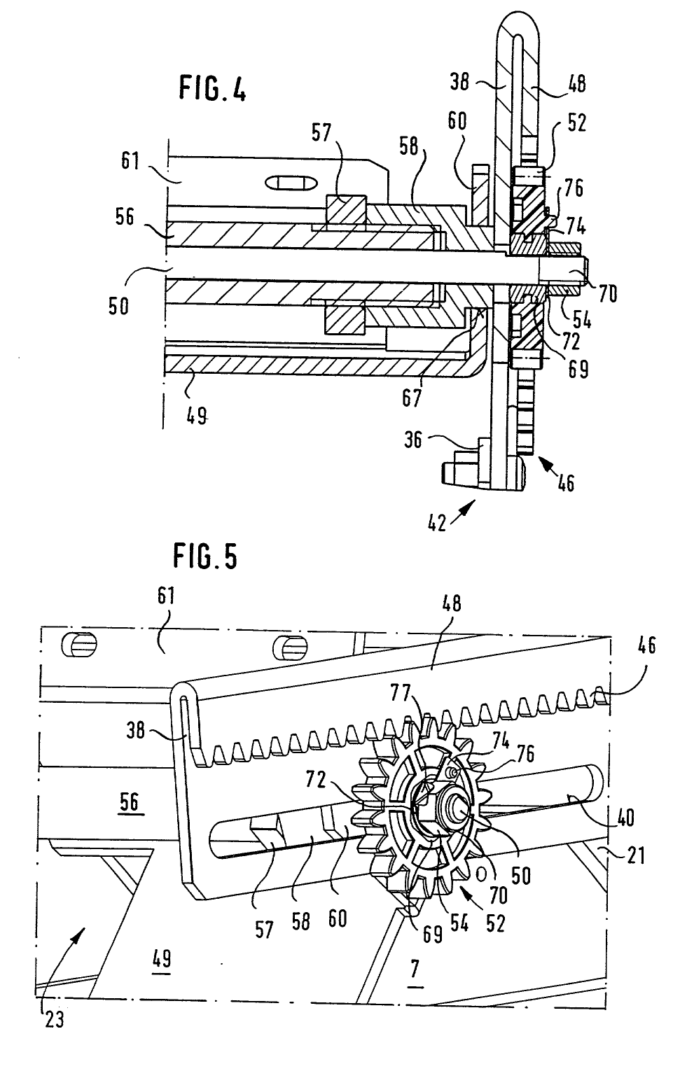

It is evident from the part section in FIG. 4 that one leg 60 of the bearing part is mounted only indirectly on the clamping sleeve 56, to be precise on an extension 67 formed on the adjusting nut 58. Furthermore, FIG. 4 shows that the ends of the supporting shaft 50 are each designed with a D-profile, in other words are each provided with an axially parallel face, not designated in any more detail, so that the gearwheels 51, 52 can be connected to the supporting shaft 50 by being slipped on and reliable twist prevention is thus afforded between the supporting shaft 50 and the gearwheels 51, 52. That is to say, the centering bushes 68, 69 embedded as insert parts into the gearwheels 51, 52 produced from plastic are provided with orifices of D-shaped cross section. Moreover, the ends of the supporting shaft 50 have threads which are assigned to the stop nuts 53, 54 and of which that illustrated in FIG. 4 is designated by 70. Retaining washers assigned to the stop nuts 53, 54 are designated by 71, 72. Integrally formed on each of the retaining washers 71, 72 is an arm 73, 74 which is in engagement in each case with a tenon 75, 76 integrally formed on the gearwheels 51, 52 when the stop nuts 53, 54 are located in the position corresponding to the necessary play between the gearwheels 51, 52 and the guide rails 37, 38. Furthermore, for securing the stop nuts 53, 54, there is at least one tab 77 designed on the retaining washers 71, 72 (FIG. 5) which is positively connected to the respective stop nut 53, 54 when the axial play of the supporting shaft 50 is set at the order of magnitude of 0.3 mm. In contrast to this, it may be envisaged to use in each case two nuts lockable relative to one another for setting the axial play and for axially securing the gearwheels 51, 52.

For the sake of completeness, it may also be stressed that there must be axial play both between the guide rails 37, 38 and the clamping means and between the guide rails 37, 38 and the gearwheels 51, 52 attached to the supporting shaft, in order to achieve an easy adjustment of the steering-column/instrument-panel structural unit. The overall play must, however, be dimensioned such that it is smaller than the possible stroke of the clamping element, but ultimately so small that as rapid a detention as possible and a maximum holding force can be achieved.

What is claimed is:

1. Stabilizing device for an instrument panel which is arranged in a variable position in a motor vehicle and which, on the other hand, is fixedly connected to a steering column carrying the steering wheel and mounted axially adjustably and pivotably and, on the other hand, is held in a variable position by means of the stabilizing device, the stabilizing device comprising a carrier which is capable of being fastened to a front frame of the driver's cab of a vehicle and which is provided with guide rails which are arranged parallel to one another and carry toothings and in which slots are formed parallel to the toothings, having a supporting shaft which passes through the slots and on which are fastened gearwheels in engagement with the toothings of the guide rails, and containing an axially acting clamping means arranged on the supporting shaft and intended for detaining the supporting shaft between the guide rails, characterized in that the toothing (45, 46) assigned to a guide rail (37, 38) is formed directly on the guide rail (37, 38), and the guide rail (37, 38) is shaped in such a way that the toothing (45, 46) points toward the guide plane of the supporting shaft (50), said guide plane being determined by the slot (39, 40), in that a twist-preventing profile is formed at each of the ends of the supporting shaft (50), in that the gearwheels (51, 52) are connectable to the supporting shaft (50) solely in a pluggable manner, and in that means are provided for securing the gearwheels (51, 52) axially on the supporting shaft (50).

2. Stabilizing device according to claim 1, characterized in that the gearwheels (51, 52) are secured axially in each case by means of a stop nut (53, 54) which is connectable to the supporting shaft (50) and is assigned a twist-preventing means.

3. Stabilizing device according to claim 1, characterized in that the two guide rails (37, 38) are formed directly on the carrier (34).

4. Stabilizing device according to claim 1, characterized in that the carrier (34) and the guide rails (37, 38) are shaped from sheet steel.

5. Stabilizing device according to claim 1, characterized in that the gearwheels (51, 52) are produced from plastic with centering bushes (68, 69) designed as insert parts, the centering bushes (68, 69) having offices corresponding to the profile of the supporting shaft (50).

6. Stabilizing device according to claim 2, characterized in that retaining washers (71, 72) are provided as twist-preventing means for the stop nuts (53, 54), in that an arm (73, 74) is formed on each retaining washer (71, 72), in that a structure cooperating in a twist-preventing manner with the arms (73, 74) is integrally formed on the gearwheels (51, 52), and in that at least one tab (77) is formed on each of the retaining washers (71, 72) in such a way that said tab can be connected positively to the respective stop nut (53, 54).
